(19) United States
(12) Patent Application Publication
(10) Pub. No.: US 2023/0342951 A1
(43) Pub. Date: Oct. 26, 2023

(54) OBJECT TRACKING APPARATUS, OBJECT TRACKING METHOD, AND PROGRAM

(71) Applicant: NEC Corporation, Tokyo (JP)

(72) Inventors: Kyosuke YOSHIMURA, Tokyo (JP); Soma SHIRAISHI, Tokyo (JP); Yasunori BABAZAKI, Tokyo (JP)

(73) Assignee: NEC Corporation, Tokyo (JP)

(21) Appl. No.: 18/136,585

(22) Filed: Apr. 19, 2023

(30) Foreign Application Priority Data
Apr. 26, 2022 (JP) 2022-072623

(51) Int. Cl. G06T 7/246; G06T 7/70; G06V 10/74

(52) U.S. Cl. CPC G06T 7/248; G06T 7/70; G06V 10/761; G06T 2207/10016

(57) ABSTRACT

In order to attain an example object of further improving accuracy in tracking a tracking target in an image sequence, an object tracking apparatus includes: an image acquisition section of acquiring an image from an image sequence; a detection section of detecting an object region including an object from the image, and calculating an evaluation value related to the object region; a decision section of deciding, in accordance with the evaluation value, to what degree appearance similarity based on appearance features of the object and the tracking target is referred to among a plurality of types of similarity used to associate the object region with a tracking target in the image sequence; and an identification section of referring to at least any of the plurality of types of similarity based on a decision result to identify a correspondence between the object region and the tracking target.

This application is based upon and claims the benefit of priority from Japanese patent application No. Tokugan 2022-072623, filed on Apr. 26, 2022, the disclosure of which is incorporated herein in its entirety by reference.

### TECHNICAL FIELD

The present invention relates to a technique for tracking an object included in an image sequence.

### BACKGROUND ART

A technique for tracking an object included in an image sequence is known. For example, Non-Patent Literature 1 discloses a technique for associating a tracking target with a region of an object detected with high reliability in an image included in an image sequence based on a position of the region. In the technique, if a region of an object detected with low reliability in the image is around a predicted position of the tracking target, the region with low reliability is associated with the tracking target based on a position of the region.

In a technique disclosed in Non-Patent Literature 2, first, a tracking target is, based on an appearance feature, associated with a region of an object detected in an image included in an image sequence. Next, in the technique, association is carried out based on a position of the region of the object and a predicted position of the tracking target.

Moreover, in a technique disclosed in Patent Literature 1, tracking target information including an appearance feature and a position is stored for a tracking target. In the technique, a change region extracted from an image included in an image sequence is associated with the tracking target with reference to the tracking target information. Moreover, in the technique, the tracking target information is updated based on an appearance feature and a position of the associated change region. However, in the technique, in a case where a change region is associated with a plurality of tracking targets, only positions included in tracking target information are updated, and appearance features are not updated for tracking targets other than a tracking target in a foreground.

### CITATION LIST

### Non-Patent Literature

### [Non-patent Literature 1]

Yifu Zhang et. al., “ByteTrack: Multi-Object Tracking by Associating Every Detection Box”, arXiv:2110.06864v2 [cs.CV] 14 Oct. 2021

### [Non-patent Literature 2]

Nicolai Wojke et. al., “SIMPLE ONLINE AND REALTIME TRACKING WITH A DEEP ASSOCIATION METRIC”, arXiv:1703.07402v1 [cs.CV] 21 Mar. 2017

### Patent Literature

### [Patent Literature 1]

Japanese Patent Application Publication Tokukai No. 2010-39580

### SUMMARY OF INVENTION

### Technical Problem

In the technique disclosed in Non-Patent Literature 1, in a case where predicted positions of a plurality of tracking targets are similar to each other, there is a possibility that tracking accuracy is not good depending on which tracking target is associated with a detected region. In the technique disclosed in Non-Patent Literature 2, a position of a region is not considered in first carrying out association with use of an appearance feature. In this technique, therefore, for a tracking target for which an appearance feature has greatly changed, a region of a positionally-distant object which is similar to the appearance feature before the change may be associated with that tracking target, and tracking accuracy may not be sufficient. In the technique disclosed in Patent Literature 1, although appearance features are not updated for tracking targets other than the tracking target in the foreground, appearance features are also referred to in carrying out association with tracking targets other than the tracking target in the foreground. Therefore, there is a possibility that tracking accuracy is not sufficient.

An example aspect of the present invention is accomplished in view of the above problem, and its example object is to provide a technique for further improving accuracy in tracking a tracking target in an image sequence.

### Solution to Problem

An object tracking apparatus according to an example aspect of the present invention includes at least one processor, the at least one processor carrying out: an image acquisition process of acquiring an image from an image sequence; a detection process of detecting an object region including an object from the image, and calculating an evaluation value related to the object region; a decision process of deciding, in accordance with the evaluation value, to what degree appearance similarity is referred to among a plurality of types of similarity which are used to associate the object region with a tracking target in the image sequence, the appearance similarity being based on appearance features of the object and the tracking target; and an identification process of referring to at least any of the plurality of types of similarity based on a decision result in the decision process to identify a correspondence between the object region and the tracking target.

An object tracking method in accordance with an example aspect of the present invention includes: acquiring an image from an image sequence; detecting an object region including an object from the image, and calculating an evaluation value related to the object region; deciding, in accordance with the evaluation value, to what degree appearance similarity is referred to among a plurality of types of similarity which are used to associate the object region with a tracking target in the image sequence, the appearance similarity being based on appearance features of the object and the tracking target; and referring to at least any of the plurality of types of similarity based on a decision result to identify a correspondence between the object region and the tracking target.

A non-transitory storage medium storing a program according to an example aspect of the present invention is a storage medium storing a program for causing a computer to function as an object tracking apparatus, the program causing the computer to carry out: an image acquisition process of acquiring an image from an image sequence; a detection process of detecting an object region including an object from the image, and calculating an evaluation value related to the object region; a decision process of deciding, in accordance with the evaluation value, to what degree appearance similarity is referred to among a plurality of types of similarity which are used to associate the object region with a tracking target in the image sequence, the appearance similarity being based on appearance features of the object and the tracking target; and an identification process of referring to at least any of the plurality of types of similarity based on a decision result in the decision process to identify a correspondence between the object region and the tracking target.

### Advantageous Effects of Invention

According to an example aspect of the present invention, it is possible to further improve accuracy in tracking a tracking target in an image sequence.

### BRIEF DESCRIPTION OF DRAWINGS

FIG. 1 is a block diagram illustrating a configuration of an object tracking apparatus according to a first example embodiment.

FIG. 2 is a flowchart for describing a flow of an object tracking method according to the first example embodiment.

FIG. 3 is a block diagram illustrating a configuration of an object tracking apparatus according to a second example embodiment.

FIG. 4 is a flowchart for describing a flow of an object tracking method according to the second example embodiment.

FIG. 5 is a diagram for describing a specific example of tracking target information in the second example embodiment.

FIG. 6 is a schematic diagram for describing a specific example of an object region in the second example embodiment.

FIG. 7 is a flowchart illustrating a specific example of a first correspondence identification process in the second example embodiment.

FIG. 8 is a schematic diagram illustrating a specific example of a process of extracting an appearance feature in the second example embodiment.

FIG. 9 is a diagram for describing a specific example of a similarity matrix related to a high evaluation object region in the second example embodiment.

FIG. 10 is a flowchart illustrating a specific example of a second correspondence identification process in the second example embodiment.

FIG. 11 is a diagram for describing a specific example of a similarity matrix related to a low evaluation object region in the second example embodiment.

FIG. 12 is a flowchart illustrating a specific example of a management process in the second example embodiment.

FIG. 13 is a flowchart illustrating a flow of an object tracking method according to Variation 1 of the second example embodiment.

FIG. 14 is a flowchart illustrating a flow of an object tracking method according to Variation 2 of the second example embodiment.

FIG. 15 is a block diagram illustrating an example of a hardware configuration of the object tracking apparatus according to each of the example embodiments.

### EXAMPLE EMBODIMENTS

### First Example Embodiment

The following description will discuss a first example embodiment of the present invention in detail with reference to the drawings. The present example embodiment is a basic form of example embodiments described later.

### Configuration of Object Tracking Apparatus 1

The following description will discuss a configuration of an object tracking apparatus 1 according to the present example embodiment, with reference to FIG. 1. FIG. 1 is a block diagram illustrating the configuration of the object tracking apparatus 1.

As illustrated in FIG. 1, the object tracking apparatus 1 includes an image acquisition section 11, a detection section 12, a decision section 13, and an identification section 14. The image acquisition section 11 acquires an image from an image sequence. The detection section 12 detects an object region including an object from the image, and calculates an evaluation value related to the object region. The decision section 13 decides, in accordance with the evaluation value, to what degree appearance similarity is referred to among a plurality of types of similarity which are used to associate the object region with a tracking target in the image sequence. The appearance similarity is based on appearance features of the object and the tracking target. The identification section 14 refers to at least any of the plurality of types of similarity based on a decision result by the decision section 13, and identifies a correspondence between the object region and the tracking target. Details of each of the sections will be described in “Flow of object tracking method S1” later.

### Flow of Object Tracking Method S1

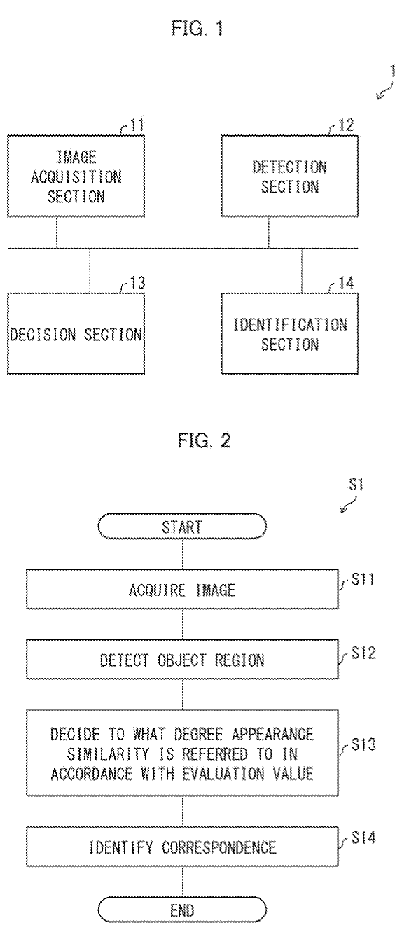

The object tracking apparatus 1 configured as described above carries out an object tracking method S1 according to the present example embodiment. The following description will discuss a flow of the object tracking method S1 with reference to FIG. 2. FIG. 2 is a flowchart for describing the flow of the object tracking method S1. As illustrated in FIG. 2, the object tracking method S1 includes steps S11 through S14.

### Step S11

In step S11, the image acquisition section 11 acquires an image from an image sequence. Here, the image sequence is a sequence in which a plurality of images are arranged in order from the beginning. Each of the plurality of images may include one or more objects as subjects.

### Step S12

In step S12, the detection section 12 detects an object region including an object from the acquired image, and calculates an evaluation value related to the object region. For example, the detection section 12 detects an object region with use of a known object detection technique for detecting an object region from an image. The detection section 12 may calculate, as an evaluation value, an index which is calculated along with detection of an object region by the object detection technique, or may calculate an evaluation value with use of a technique different from the object detection technique.

### Step S13

In step S13, the decision section 13 decides, in accordance with the evaluation value, to what degree appearance similarity is referred to among a plurality of types of similarity which are used to associate the object region with a tracking target in the image sequence. The appearance similarity is based on appearance features of the object and the tracking target. For example, the decision section 13 may decide whether or not to refer to the appearance similarity. Alternatively, for example, the decision section 13 may decide weights which are respectively given to the plurality of types of similarity including appearance similarity. In this case, the decision section 13 may increase, as the evaluation value increases, the weight which is given to the appearance similarity.

Here, the tracking target in the image sequence is an object which is a target to be tracked among objects which are included as subjects in images constituting the image sequence. The appearance similarity is similarity between an appearance feature of an object and an appearance feature of a tracking target. Note that the appearance feature of the object can be extracted based on an object region. Moreover, the appearance feature of the tracking target can be extracted based on a tracking target region including the tracking target. The tracking target region is, for example, a region detected from another image including the tracking target in the image sequence.

### Step S14

In step S14, the identification section 14 refers to at least any of the plurality of types of similarity based on a decision result in step S13, and identifies a correspondence between the object region and the tracking target. For example, in a case where it has been decided to refer to the appearance similarity, the identification section 14 refers to the appearance similarity and at least one other type of similarity among the plurality of types of similarity to decide a correspondence between the object region and the tracking target. Meanwhile, for example, in a case where it has been decided not to refer to the appearance similarity, the identification section 14 refers to at least one other type of similarity to decide a correspondence between the object region and the tracking target without using the appearance similarity. For example, in a case where weights which are respectively given to a plurality of types of similarity have been decided by the decision section 13, the identification section 14 decides a correspondence between the object region and the tracking target with reference to the plurality of types of similarity to which the weights have been given.

### Program Implementation Example

In a case where the object tracking apparatus 1 is configured by a computer, a program below is stored in a memory which is referred to by the computer. The program is a program for causing a computer to function as the object tracking apparatus 1, the program causing the computer to function as: the image acquisition section 11 of acquiring an image from an image sequence; the detection section 12 of detecting an object region including an object from the image, and calculating an evaluation value related to the object region; the decision section 13 of deciding, in accordance with the evaluation value, to what degree appearance similarity is referred to among a plurality of types of similarity which are used to associate the object region with a tracking target in the image sequence, the appearance similarity being based on appearance features of the object and the tracking target; and the identification section 14 of referring to at least any of the plurality of types of similarity based on a decision result by the decision section 13 to identify a correspondence between the object region and the tracking target.

The above described object tracking method S1 is realized when the computer reads the program from the memory and executes the program.

### Effect of the Present Example Embodiment

As described above, the present example embodiment employs a configuration of: acquiring an image from an image sequence; detecting an object region including an object from the image, and calculating an evaluation value related to the object region; deciding, in accordance with the evaluation value, to what degree appearance similarity is referred to among a plurality of types of similarity which are used to associate the object region with a tracking target in the image sequence, the appearance similarity being based on appearance features of the object and the tracking target; and referring to at least any of the plurality of types of similarity based on a decision result to identify a correspondence between the object region and the tracking target.

Therefore, according to the present example embodiment, it is possible to improve accuracy in tracking a tracking target in accordance with to what degree the appearance similarity is referred to among the plurality of types of appearance similarity. For example, for an object region for which an evaluation value is relatively high, it is highly possible that an appearance feature of the object can be well extracted. Therefore, for such an object region, a correspondence with the tracking target can be accurately identified by increasing the degree that the appearance similarity is referred to. Meanwhile, for example, for an object region for which an evaluation value is relatively low, it is highly possible that it is difficult to extract an appearance feature of the object. Therefore, the degree that appearance similarity is referred to is lowered for such an object region, and an appearance feature with low accuracy is not referred to. Therefore, it is possible to accurately identify a correspondence with the tracking target. As a result, accuracy in tracking the tracking target is improved.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

### Configuration of Object Tracking Apparatus 1A

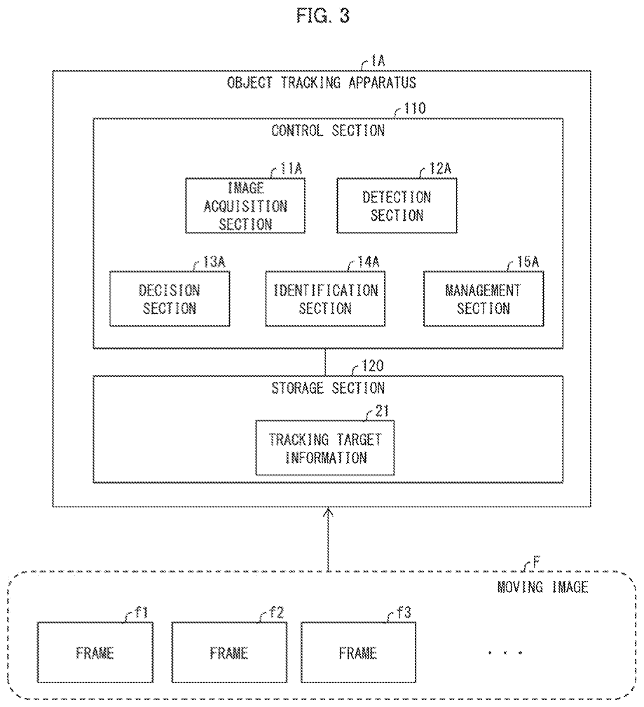

An object tracking apparatus 1A according to the second example embodiment is an apparatus that tracks an object by inferring identity of an object detected in each of frames of a moving image F in which one or more objects are captured. An object which is to be tracked is referred to as a tracking target. The number of tracking targets may be one or may be two or more. The following description will discuss a configuration of the object tracking apparatus 1A with reference to FIG. 3. FIG. 3 is a block diagram illustrating the configuration of the object tracking apparatus 1A. As illustrated in FIG. 3, the object tracking apparatus 1A includes a control section 110 and a storage section 120. The object tracking apparatus 1A is capable of receiving input of a moving image F.

### Control Section 110

The control section 110 collectively controls the sections of the object tracking apparatus 1A. The control section 110 includes an image acquisition section 11A, a detection section 12A, a decision section 13A, an identification section 14A, and a management section 15A. The image acquisition section 11A is configured in a manner similar to the image acquisition section 11 in the first example embodiment. The detection section 12A, the decision section 13A, and the identification section 14A are configured to be substantially similar to respective sections having the same names in the first example embodiment, but details thereof are different. The management section 15A manages a tracking target in the moving image F. The storage section 120 stores tracking target information 21. The storage section 120 also stores various kinds of data used by the control section 110. Details of each of these sections will be described in “Flow of object tracking method S1A” later.

### Moving Image F

The moving image F is a moving image in which a plurality of objects are captured, and is a sequence of a plurality of frames f1, f2, f3, and so forth. The frames f1, f2, f3, and so forth are arranged in order of a captured time. Each of the frames f1, f2, f3, and so forth may include one or more objects or may not include a single object depending on motion of an object which is a subject, change in an angle of view of a camera which has captured the moving image F, or the like. Here, the moving image F is an example of the image sequence recited in claims. Each of the frames f1, f2, f3, and so forth is an example of the image recited in claims.

Hereinafter, in some cases, each of the frames f1, f2, f3, and so forth is simply referred to as a frame when it is not necessary to particularly distinguish between the frames f1, f2, f3, and so forth. Moreover, f1, f2, and f3 are each also referred to as an identifier of the frame. A frame which is to be subjected to a process is also referred to as a target frame. A frame closer to the beginning (frame f1) of the moving image F than the target frame is referred to as “a frame before the target frame”, “a past frame of the target frame”, and the like. A frame which is adjacent to the target frame on the beginning side of the moving image F is referred to as “a frame immediately before the target frame” or the like. A frame which is adjacent to the target frame on the end side of the moving image F is referred to as “a next frame of the target frame” or the like.

### Positional Similarity: Intersection Over Union

In the present example embodiment, the plurality of types of similarity referred to by the identification section 14A include positional similarity in addition to appearance similarity. The positional similarity is similarity that is based on a position of an object region in a frame in which the object region has been detected and on a position of a tracking target region that is associated with a tracking target. For example, the tracking target region is a region including a tracking target in at least any of frames before a target frame (i.e., a frame in which the object region has been detected). The positional similarity can be intersection over union (IoU) between the object region and the tracking target region. Hereinafter, in the present example embodiment, it is assumed that IoU is used as the positional similarity.

Note, however, that the positional similarity is not limited to the above described example.

### Flow of Object Tracking Method S1A

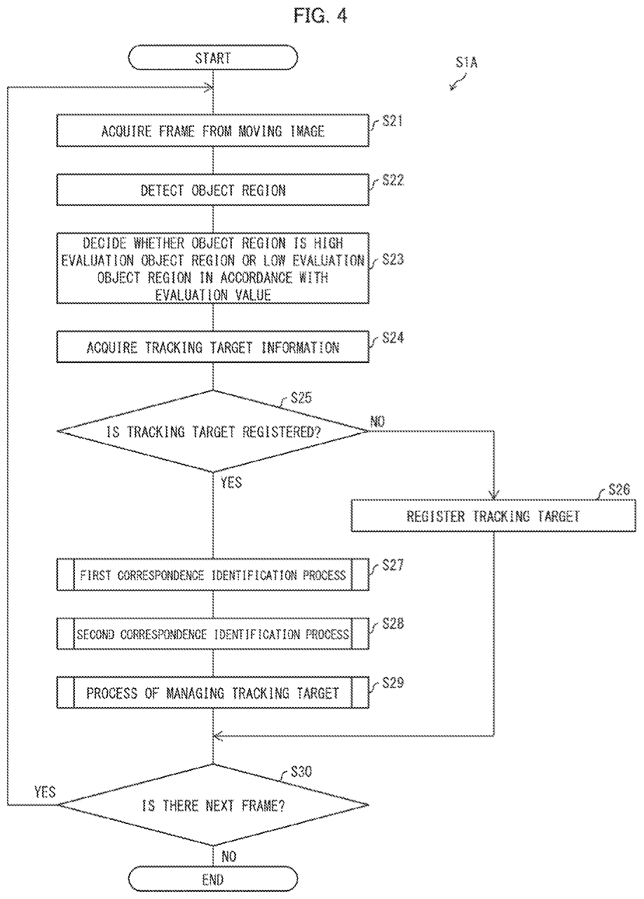

The object tracking apparatus 1A configured as described above carries out an object tracking method S1A according to the second example embodiment. The following description will discuss a flow of the object tracking method S1A with reference to FIG. 4. FIG. 4 is a flowchart for describing the flow of the object tracking method S1A. As illustrated in FIG. 4, the object tracking method S1A includes steps S21 through S30.

### Step S21

In step S21, the image acquisition section 11A acquires a target frame from the moving image F. The target frame which is acquired here is a frame closest to the beginning among frames which have not yet been processed in the moving image F. For example, first, the image acquisition section 11A acquires a beginning frame f1 from the moving image F.

### Step S22

In step S22, the detection section 12A detects an object region including an object from the target frame. For example, the detection section 12A may identify a classification of an object included in an object region to detect an object region including an object of predetermined classification.

For example, the detection section 12A can utilize a known object detection technique for detecting an object region from an image. Specific examples of such a technique include You Only Look Once (Yolo), EfficientDet, and the like for detecting a rectangular object region (bounding box). Other specific examples of such a technique include CenterNet for detecting a center of an object, and the like. Alternatively, the detection section 12A can use, for example, a technique for detecting a segmentation-type object region, a technique for detecting a feature point of an object, or the like. Note, however, that the object detection technique used by the detection section 12A is not limited to the above described examples. In the following description, an example in which the object region is a bounding box is mainly described, but the shape of the object region is not limited to this.

Moreover, the detection section 12A calculates an evaluation value based on reliability that the object is included in the object region or on a degree that the object is hidden in the object region. For example, the detection section 12A may use, as the evaluation value, a reliability score that is calculated by the object detection technique described above with respect to an object region. For example, the detection section 12A may calculate an evaluation value based on a degree that the object is hidden, in accordance with a degree of overlap of a plurality of object regions, a relationship between a foreground and a background, or the like. The evaluation value is not limited to the above described example, as long as the evaluation value represents evaluation related to an object region. In the following descriptions, it is assumed that a larger value of the evaluation value represents higher evaluation. For example, in a case where an evaluation value based on a degree that the object is hidden is used, it is assumed that the evaluation value is smaller as the degree that the object is hidden is larger, and that the evaluation value is larger as the degree that the object is hidden is smaller.

### Specific Example 1 of Object Region

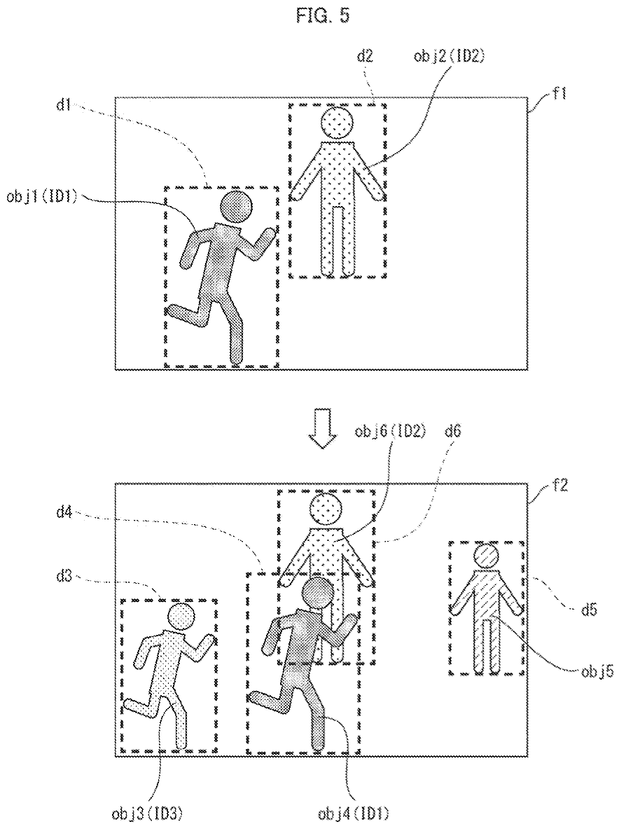

The following description will discuss a specific example of an object region detected in step S22 for the frame f1, with reference to FIG. 5. FIG. 5 is a schematic diagram for describing a specific example of an object region. As illustrated in FIG. 5, the detection section 12A detects, from the frame f1, an object region d1 including an object obj1 and an object region d2 including an object obj2. In this example, the object regions d1 and d2 are each represented as a rectangle (bounding box) including the object.

FIG. 5 illustrates a plurality of object regions in a single frame. However, the number of object regions detected in each of the frames may be one or may be two or more. In a case where no object region is detected in a frame, the object tracking apparatus 1A carries out step S30 (described later), and if there is a next frame, the process proceeds to that frame.

### Step S23

In step S23 of FIG. 4, for each of the object regions, the decision section 13A decides, in accordance with an evaluation value related to that object region, whether that object region is regarded as a high evaluation object region for which appearance similarity is referred to or a low evaluation object region for which appearance similarity is not referred to. The high evaluation object region is an example of the first object region recited in claims. The low evaluation object region is an example of the second object region recited in claims.

For example, in a case where a high evaluation condition indicating that the evaluation value of the object region is high is satisfied, the decision section 13A may decide the object region as a high evaluation object region. The following expression (1) represents an example of the high evaluation condition.

θ_{high}≤score≤1.0 (1)

Expression (1) indicates a condition that an evaluation value score is not less than a threshold θhigh and not greater than 1.0. In the example of FIG. 5, it is assumed that both the object regions d1 and d2 are high evaluation object regions.

For example, in a case where a low evaluation condition indicating that the evaluation value of the object region is low is satisfied, the decision section 13A may decide the object region as a low evaluation object region. The following expression (2) represents an example of the low evaluation condition.

0≤θ_{low}≤score<θ_{high} (2)

Expression (2) indicates a condition that an evaluation value score is not less than a threshold θlow and is less than the threshold θhigh.

### Step S24

In step S24 of FIG. 4, the management section 15A acquires tracking target information 21 from the storage section 120.

### Specific Example 1 of Tracking Target Information 21

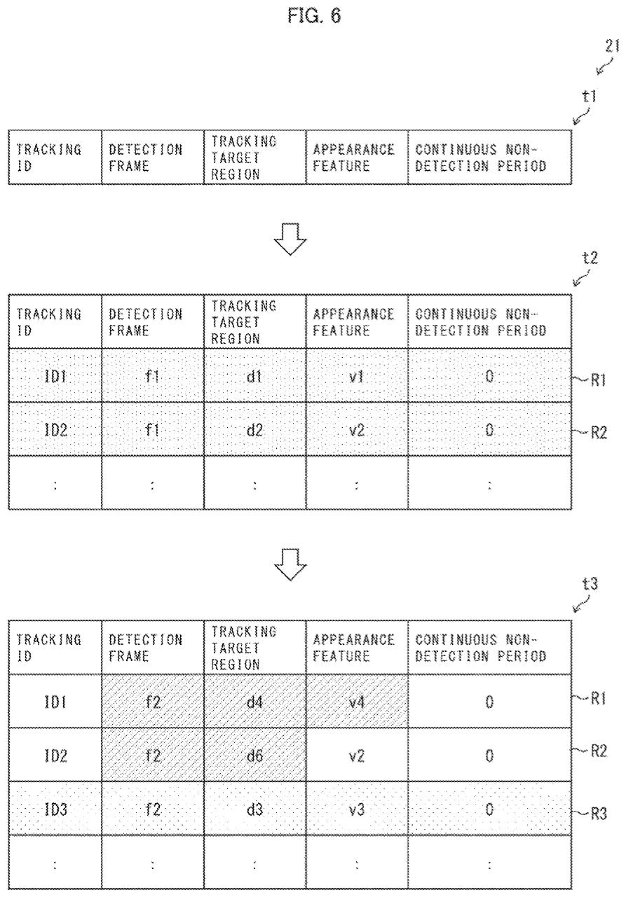

The tracking target information 21 includes information indicating a tracking target. The following description will discuss a specific example of the tracking target information 21 with reference to FIG. 6. FIG. 6 is a diagram for describing a specific example of the tracking target information 21. As illustrated in FIG. 6, the tracking target information 21 includes a tracking ID, a detection frame, a tracking target region, an appearance feature, and a continuous non-detection period.

The tracking ID is used to identify a tracking target. Hereinafter, a tracking target with a tracking ID of ID1 is also referred to as a tracking target ID1. The detection frame is information for identifying a frame in which the corresponding tracking target has been detected. Here, an identifier of a detection frame is used. Note, however, that the detection frame is not limited to the identifier of the detection frame, and may be information that indicates a shooting time of a corresponding detection frame or a playback position of a corresponding detection frame (i.e., an elapsed time in a case of playback from the beginning). The tracking target region indicates a region including a corresponding tracking target in the detection frame. For example, the tracking target region is represented by a bounding box. The appearance feature indicates an appearance feature of the tracking target. The continuous non-detection period represents a period in which the tracking target is not detected continuously in the moving image F. In this example, the continuous non-detection period is represented by the number frames in which the tracking target is not detected continue. Note, however, that the continuous non-detection period is not limited to this, and may be represented by, for example, a length of a playback time in which the tracking target is not detected, or may be represented by another index.

For example, in a case where the frame f1 is acquired in step S21, the tracking target information 21 does not include the tracking target yet in step S24. Hereinafter, an operation of newly including information indicating the tracking target in the tracking target information 21 is also referred to as registration of the tracking target. A registration status t1 illustrated in FIG. 6 schematically illustrates a status of the tracking target information 21 in which the tracking target has not been registered.

### Step S25

In step S25 of FIG. 4, the management section 15A determines whether or not at least one tracking target is registered in the tracking target information 21. In this example, the tracking target information 21 in the registration status t1 illustrated in FIG. 6 is acquired, and therefore it is determined to be No in this step.

### Step S26

Step S26 is carried out in a case where it has been determined to be No in step S25. In step S26, the management section 15A registers an object included in the object region detected in step S22 in the tracking target information 21 as a tracking target. For example, it is possible that the management section 15A registers an object included in a high evaluation object region as a tracking target, and does not register an object included in a low evaluation object region as a tracking target.

The following description will discuss an example in which step S26 is carried out while using the frame f1 as a target frame, with reference to FIGS. 5 and 6. The management section 15A gives a tracking ID1 to an object obj1 included in a high evaluation object region d1 of the frame f1. The management section 15A extracts an appearance feature v1 of the object obj1. The management section 15A gives a tracking ID2 to an object obj2 included in a high evaluation object region d2. The management section 15A extracts an appearance feature v2 of the object obj2. An example of a process of extracting the appearance feature will be described later.

The management section 15A registers the tracking targets ID1 and ID2 in the tracking target information 21. Thus, as illustrated in a registration status t2 of FIG. 6, the tracking target information 21 includes pieces of information R1 and R2 related to the tracking targets ID1 and ID2. The information R1 includes a tracking ID of “ID1”, a detection frame of “f1”, a tracking target region of “d1”, an appearance feature of “v1”, and a continuous non-detection period of “0”. The information R2 includes a tracking ID of “ID2”, a detection frame of “f1”, a tracking target region of “d2”, an appearance feature of “v2”, and a continuous non-detection period of “0”. In accordance with the fact that the objects obj1 and obj2 are managed as the tracking targets ID1 and ID2, the object regions d1 and d2 are registered as tracking target regions d1 and d2. In FIG. 6, information shaded in light gray schematically illustrates newly registered information.

After that, the management section 15A carries out step S30 (described later), and if there is a next frame, the process proceeds to that frame. Here, the processes from step S21 are carried out for the next frame f2.

### Steps S21 through S24

In step S21, the image acquisition section 11A acquires a next target frame from the moving image F. Here, an example in which the frame f2 is acquired will be described. In step S22, the detection section 12A detects an object region from the frame f2 and calculates an evaluation value.

### Specific Example 2 of Object Region

The following description will discuss a specific example of an object region detected in step S22 for the frame f2, with reference to FIG. 5. As illustrated in FIG. 5, the detection section 12A detects, from the frame f2, an object region d3 including an object obj3, an object region d4 including an object obj4, an object region d5 including an object obj5, and an object region d6 including an object obj6.

In step S24, the management section 15A acquires the tracking target information 21 in the registration status t2 illustrated in FIG. 6. In step S23, it is assumed that the decision section 13A has determined that the object regions d3 and d4 are high evaluation object regions and also has determined that the object regions d5 and d6 are low evaluation object regions. In step S24, the management section 15A acquires the tracking target information 21 in the registration status t2 illustrated in FIG. 6. Therefore, at least one tracking target is registered in the tracking target information 21, and therefore a determination result in step S25 is Yes.

### Step S27

Step S27 of FIG. 4 is carried out in a case where it has been determined to be Yes in step S25. In step S27, the identification section 14A carries out a first correspondence identification process. The first correspondence identification process is a process of identifying a correspondence between each of tracking targets and a high evaluation object region.

### Specific Example of First Correspondence Identification Process

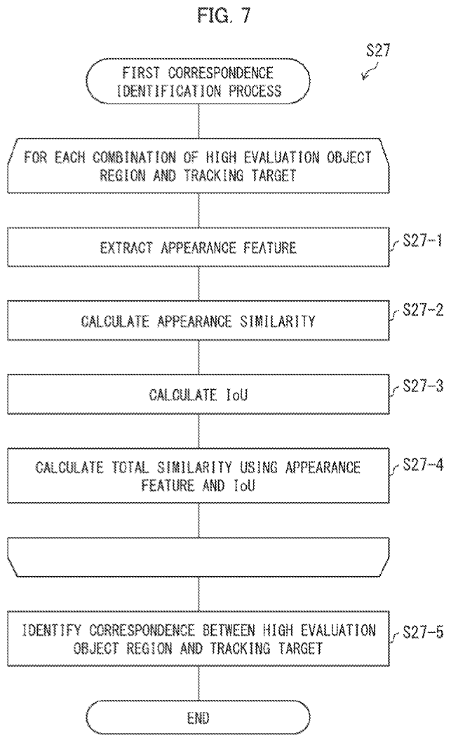

The following description will discuss a specific example of the first correspondence identification process with reference to FIG. 7. FIG. 7 is a flowchart illustrating a specific example of the first correspondence identification process. As illustrated in FIG. 7, the first correspondence identification process includes steps S27-1 through S27-5. Among these steps, steps S27-1 through S27-4 are processes which are carried out for each combination of one or more high evaluation object regions and one or more tracking targets. The high evaluation object region and the tracking target included in each of the combinations are referred to as the corresponding high evaluation object region and the corresponding tracking target. By carrying out these steps for each of the combinations, a similarity matrix (described later) is generated. Step S27-5 is a process carried out for the similarity matrix.

### Step S27-1

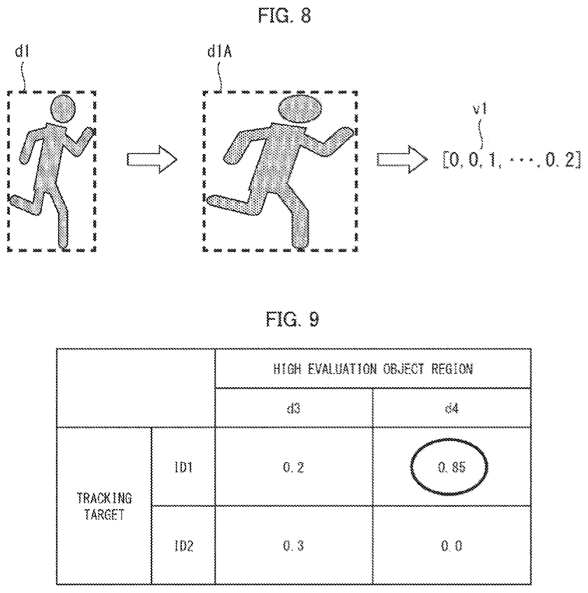

In step S27-1, the identification section 14A extracts, from the corresponding high evaluation object region, an appearance feature of an object included in the corresponding high evaluation object region. The following description will discuss a specific example of a process of extracting an appearance feature, with reference to FIG. 8. FIG. 8 is a schematic diagram illustrating a specific example of the process of extracting an appearance feature.

As illustrated in FIG. 8, the identification section 14A normalizes an image of the high evaluation object region d1 to a predetermined size to generate an image d1A. Moreover, the identification section 14A extracts a feature vector of a fixed length from the normalized image d1A. The feature vector can be extracted by use of, for example, a neural network such as a convolutional neural network (CNN). The identification section 14A regards the extracted feature vector as an appearance feature. Such a specific example of the process of extracting an appearance feature is also applicable to, for example, extraction of an appearance feature of the tracking target in the foregoing step S26. Note that the process of extracting an appearance feature is not limited to the above described example.

### Step S27-2

In step S27-2 of FIG. 7, the identification section 14A calculates appearance similarity between an object included in the corresponding high evaluation object region and the corresponding tracking target. For example, the identification section 14A calculates, as the appearance similarity, cosine similarity between the appearance feature extracted in step S27-1 and the appearance feature of the corresponding tracking target stored in the tracking target information 21. In this example, the tracking target information 21 registers an appearance feature extracted in a detection frame in which the corresponding tracking target has been most recently detected. In other words, in this example, the appearance feature that has been extracted most recently for the corresponding tracking target is referred to in calculating the appearance similarity.

The following description will discuss, for example, a combination of the high evaluation object region d3 and the tracking target ID1 in the example of FIG. 5. In this case, the identification section 14A calculates, as the appearance similarity, cosine similarity between the appearance feature v3 of the object obj3 extracted from the high evaluation object region d3 and the appearance feature v1 of the tracking target ID 1 that is stored in the tracking target information 21.

### Step S27-3

In step S27-3 of FIG. 7, the identification section 14A calculates IoU between the corresponding high evaluation object region and a tracking target region associated with the corresponding tracking target. The following description will discuss, for example, a combination of the high evaluation object region d3 and the tracking target ID1 in the example of FIG. 5. In this case, in a case where the frame f1 and the frame f2 are superimposed, the identification section 14A calculates IoU between the high evaluation object region d3 and the object region d1 including the tracking target ID1 (tracking target region d1).

### Step S27-4

In step S27-4 of FIG. 7, the identification section 14A calculates total similarity for the corresponding high evaluation object region and the corresponding tracking target. In this example, the total similarity is a weighted average of appearance similarity and IoU. Note, however, that, in a case where the IoU is not greater than a threshold, the total similarity is assumed to be zero. Thus, even for a high evaluation object region, in a case where the high evaluation object region is located far away from the tracking target region, the total similarity is made to be zero so that the high evaluation object region does not correspond to the tracking target. The following expression (3) indicates an example of an expression for calculating total similarity “Similarity”.

$$Similarity = \{ \begin{matrix}0 & if IoU \leq {θ}_{iou} \\ \frac{α \cdot appearance\_similarity + β \cdot IoU}{α + β} & otherwise\end{matrix} \qquad ( 3 )$$

In expression (3), a is a weight that is given to appearance similarity “appearance_similarity”. β is a weight that is given to intersection over union IoU. θiou is a threshold of the IoU. Here, α and β are predetermined values. In other words, in a case where the decision section 13A has decided to refer to appearance similarity, the identification section 14A refers to a plurality of types of similarity 20 (appearance similarity and IoU) to which predetermined weights (α and β) are respectively given.

By carrying out the processes of steps S27-1 through S27-4 for each of the combinations of the high evaluation object regions and the tracking targets, the identification section 14A generates a similarity matrix related to the high evaluation object regions. The similarity matrix is a matrix in which total similarity of each of the combinations is used as an element.

The following description will discuss a specific example of a similarity matrix related to a high evaluation object region, with reference to FIG. 9. FIG. 9 is a diagram for describing a specific example of a similarity matrix related to a high evaluation object region. As illustrated in FIG. 9, the similarity matrix is a matrix of two rows and two columns in which total similarities of respective combinations of the high evaluation object regions d1 and d2 in the frame f2 and the tracking targets ID1 and ID2 registered in the tracking target information 21 are used as elements.

### Step S27-5

In step S27-5 of FIG. 7, the identification section 14A refers to a similarity matrix related to the high evaluation object region and identifies a correspondence between the high evaluation object region and the tracking target. For example, the identification section 14A identifies an object region corresponding to each of tracking targets by evaluating the similarity matrix related to the high evaluation object region by a Hungarian method. Note, however, that the identification section 14A does not identify, for each of the tracking targets, a correspondence with a high evaluation object region for which the total similarity is less than the threshold.

For example, the identification section 14A refers to the similarity matrix illustrated in FIG. 9, and identifies the high evaluation object region d4 that corresponds to the tracking target ID1 by the Hungarian method. That is, the object obj4 included in the high evaluation object region d4 is identified as the tracking target ID1. For the tracking target ID2, the total similarity is less than the threshold (e.g., 0.5) for any combination with the high evaluation object regions d3 and d4. Therefore, the identification section 14A does not identify a correspondence.

Thus, the specific example of the first correspondence identification process in step S27 of FIG. 4 ends.

### Step S28

In step S28 of FIG. 4, the identification section 14A carries out the second correspondence identification process. The second correspondence identification process is a process of identifying a correspondence between a low evaluation object region and each of tracking targets for which a correspondence cannot be identified in the first correspondence identification process. Note that, in a case where correspondences have already been identified for all of tracking targets registered in the tracking target information 21, or in a case where a low evaluation object region has not been detected in the target frame, the process of this step is not carried out and next step S29 is carried out.

### Specific Example of Second Correspondence Identification Process

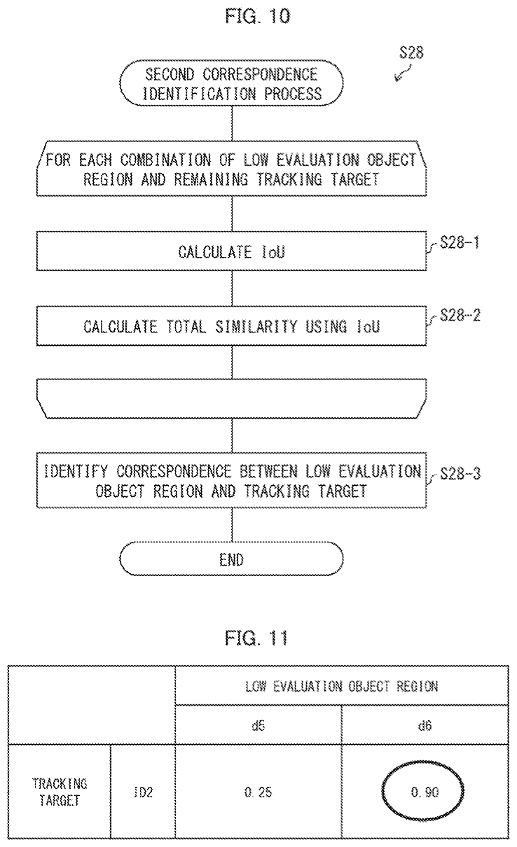

The following description will discuss a specific example of a second correspondence identification process with reference to FIG. 10. FIG. 10 is a flowchart illustrating the specific example of the second correspondence identification process. As illustrated in FIG. 10, the second correspondence identification process includes steps S28-1 through S28-3. Among these steps, steps S28-1 and S28-2 are processes which are carried out for each of combinations of one or more tracking targets for which a correspondence has not been identified yet and one or more low evaluation object regions. The low evaluation object region and the tracking target included in each of the combinations are referred to as the corresponding low evaluation object region and the corresponding tracking target. Thus, a similarity matrix (described later) is generated. Step S28-3 is a process carried out for the similarity matrix.

### Step S28-1

In step S28-1, the identification section 14A calculates IoU between the corresponding low evaluation object region and a tracking target region associated with the corresponding tracking target.

For example, in the example of FIG. 5, a correspondence has not been identified yet for the tracking target ID2. Therefore, the following description will discuss a combination of a low evaluation object region d6 and the tracking target ID2. In this case, in a case where the frame f1 and the frame f2 are superimposed, the identification section 14A calculates IoU between the low evaluation object region d6 and the object region d2 including the tracking target ID2 (tracking target region d2).

### Step S28-2

In step S28-2, the identification section 14A calculates total similarity for the corresponding low evaluation object region and the corresponding tracking target. In the second correspondence identification process, the total similarity is calculated with reference to IoU without referring to appearance similarity. For example, the identification section 14A calculates the total similarity by setting α=0 and β=1 in the above described expression (3). In other words, in a case where the decision section 13A has decided not to refer to appearance similarity, the identification section 14A refers to at least positional similarity (IoU).

By carrying out the processes of steps S28-1 and S28-2 for each of the combinations of the low evaluation object regions and the tracking targets, the identification section 14A generates a similarity matrix related to the low evaluation object regions.

The following description will discuss a specific example of a similarity matrix related to a low evaluation object region, with reference to FIG. 11. FIG. 11 is a diagram for describing a specific example of a similarity matrix related to a low evaluation object region. As illustrated in FIG. 11, the similarity matrix is a matrix of one row and two columns in which total similarities of respective combinations of the low evaluation object regions d5 and d6 in the frame f2 and the tracking target ID2 for which a correspondence has not been identified yet are used as elements.

### Step S28-3

In step S28-3, the identification section 14A refers to the similarity matrix related to the low evaluation object region and identifies a correspondence between the low evaluation object region and the tracking target. A specific example of a process of identifying a correspondence with reference to the similarity matrix is as described above in step S27-5.

For example, the identification section 14A refers to the similarity matrix illustrated in FIG. 11, and identifies the low evaluation object region d6 that corresponds to the tracking target ID2 by the Hungarian method. That is, the object obj6 included in the low evaluation object region d6 is identified as the tracking target ID2.

Thus, the specific example of the second correspondence identification process in step S28 of FIG. 4 ends.

### Step S29

In step S29 of FIG. 4, the management section 15A carries out a management process of managing the tracking target. In the management process, the tracking target information 21 is updated.

### Specific Example of Management Process

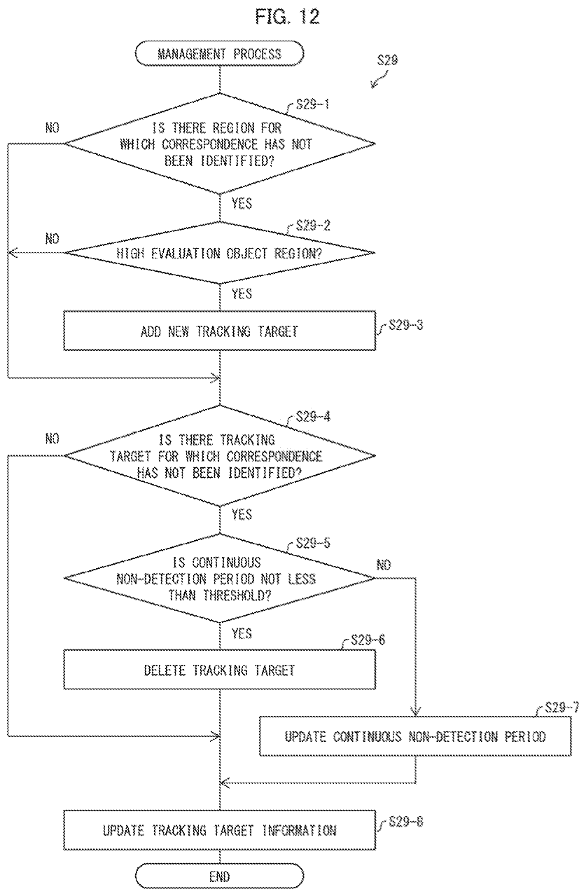

The following description will discuss a specific example of a management process with reference to FIG. 12. FIG. 12 is a flowchart illustrating a specific example of the management process. As illustrated in FIG. 12, the management process includes steps S29-1 through S29-8.

### Step S29-1

In step S29-1, the management section 15A determines whether or not there is an object region for which a correspondence with a tracking target has not been identified. In a case where it has been determined to be No in this step, processes from step S29-4 (described later) are carried out.

### Step S29-2

Step S29-2 is carried out in a case where it has been determined to be Yes in step S29-1. In step S29-2, the management section 15A determines whether or not the object region for which a correspondence has not been identified is a high evaluation object region. That is, whether or not next step S29-3 is carried out is determined in accordance with the evaluation value. In a case where it has been determined to be No in this step, processes from step S29-4 (described later) are carried out.

### Step S29-3

Step S29-3 is carried out in a case where it has been determined to be Yes in step S29-2. In step S29-3, the management section 15A adds an object included in the corresponding high evaluation object region to tracking target information 21 as another tracking target. Here, the tracking target information 21 is an example of information related to the “management target” recited in claims.

In other words, by carrying out steps S29-1 through S29-3, for an object region for which a correspondence with a tracking target cannot be identified, the management section 15A adds, in accordance with an evaluation value, an object included in the corresponding object region to management targets (tracking target information 21) as another tracking target.

For example, in the example of FIG. 5, a correspondence with any of the tracking targets ID1 and ID2 has not been identified for the high evaluation object region d3 in the frame f2. Then, the management section 15A gives a tracking ID3 to the object obj3 included in the high evaluation object region d3. Moreover, the management section 15A additionally registers the tracking target ID3 in the tracking target information 21. Thus, as illustrated in a registration status t3 of FIG. 6, the tracking target information 21 includes information R3 related to the tracking target ID3, in addition to the pieces of information R1 and R2. The information R3 includes a tracking ID of “ID3”, a detection frame of “f2”, a tracking target region of “d3”, an appearance feature of “v3”, and a continuous non-detection period of “0”. As the appearance feature of “v3”, an appearance feature extracted from the object region d3 in step S27-1 is applicable. Moreover, in accordance with the fact that the object obj3 is managed as the tracking target ID3, the object region d3 is registered as the tracking target region d3.

### Step S29-4

In step S29-4, the management section 15A determines whether or not there is a tracking target for which a correspondence with an object region has not been identified. In a case where it has been determined to be No in this step, the management process ends.

### Step S29-5

Step S29-5 is carried out in a case where it has been determined to be Yes in step S29-4. In step S29-4, for the corresponding tracking target, the management section 15A determines whether or not the continuous non-detection period stored in the tracking target information 21 is not less than a threshold. That is, the management section 15A determines, for the corresponding tracking target, whether or not the correspondence described above has not been identified in a plurality of successive images included in the moving image F.

### Step S29-6

Step S29-6 is carried out in a case where it has been determined to be Yes in step S29-5. In step S29-5, the management section 15A deletes the corresponding tracking target from the tracking target information 21.

In other words, by carrying out steps S29-4 through S29-6, the management section 15A deletes, from the management targets (tracking target information 21), a tracking target for which a correspondence with an object region has not been identified in a plurality of successive frames included in the moving image F, in accordance with a continuous non-detection period.

### Step S29-7

Step S29-7 is carried out in a case where it has been determined to be No in step S29-5. In step S29-7, the management section 15A updates, for the corresponding tracking target, a continuous non-detection period registered in the tracking target information 21. For example, in a case where the continuous non-detection period is represented by the number of frames, the management section 15A may update the continuous non-detection period by adding 1.

### Step S29-8

In step S29-8, the management section 15A updates information included in the tracking target information 21 for a tracking target for which a correspondence with an object region has been identified. Moreover, the management section 15A updates information including an appearance feature for a tracking target for which a correspondence with a high evaluation object region has been identified, and does not update an appearance feature for a tracking target for which a correspondence with a low evaluation object region has been identified.

In the example of FIG. 5, the management section 15A updates the information R1 related to the tracking target ID1 for which a correspondence with the high evaluation object region d4 has been identified. Specifically, as illustrated in the registration status t3 of FIG. 6, the detection frame is updated from “f1” to “f2”, the object region is updated from “d1” to “d4”, and the appearance feature is updated from “v1” to “v4”, in the information R1. As the appearance feature of “v4”, an appearance feature extracted from the object region d4 in step S27-1 is applicable.

Moreover, the management section 15A updates the information R2 related to the tracking target ID2 for which a correspondence with the low evaluation object region d6 has been identified. Specifically, as illustrated in the registration status t3 of FIG. 6, the detection frame of the information R2 is updated from “f1” to “f2”, and the object region is updated from “d2” to “d6”. Note, however, that the management section 15A does not update the appearance feature of “v2”. In FIG. 6, information shaded in dark gray schematically illustrates the updated information.

Thus, the specific example of the management process in step S29 of FIG. 4 ends.

### Step S30

In step S30 of FIG. 4, the control section 110 determines whether or not there is a next frame. In a case where it has been determined to be Yes in step S30, the object tracking apparatus 1A repeats the processes from step S21. In a case where it has been determined to be No in step S30, the object tracking method S1A ends.

### Effect of the Present Example Embodiment

As described above, the present example embodiment employs, in addition to a configuration similar to the first example embodiment, a configuration in which: the plurality of types of similarity further include positional similarity (IoU) which is based on a position of an object region in a target frame and on a position of a tracking target region that is associated with a tracking target. Moreover, a configuration is employed in which: in a case where it has been decided not to refer to appearance similarity for an object region in accordance with an evaluation value of that object region, at least the positional similarity is referred to.

Thus, it is possible to obtain a configuration in which both appearance similarity and positional similarity are referred to in accordance with an evaluation value of an object region, or only positional similarity is referred to in accordance with the evaluation value. As a result, a correspondence between an object region and a tracking target can be further accurately identified.

In the present example embodiment, there can be a plurality of object regions and a plurality of tracking targets. Moreover, a configuration is employed in which: whether each of the two or more object regions is regarded as a high evaluation object region or a low evaluation object region is decided in accordance with an evaluation value related to that object region, the high evaluation object region being an object region for which appearance similarity is referred to, and the low evaluation object region being an object region for which appearance similarity is not referred to; and the first correspondence identification process of identifying a correspondence between the high evaluation object region and each of the two or more tracking targets is carried out, and the second correspondence identification process of identifying a correspondence between the low evaluation object region and each tracking target for which a correspondence cannot be identified in the first correspondence identification process is carried out.

In the present example embodiment, as described above, the process of identifying a correspondence between a tracking target and an object region is carried out in two stages. In this case, a correspondence with a low evaluation object region is identified only for a tracking target for which a correspondence with a high evaluation object region cannot be identified. Thus, the correspondence can be accurately identified, as compared with a case where each of object regions is dealt with regardless of an evaluation value or a case where a low evaluation object region is not dealt with. In the present example embodiment, appearance similarity and positional similarity are referred to in the first stage in which a high evaluation object region is dealt with. Therefore, the correspondence can be accurately identified. Moreover, positional similarity is referred to without referring to appearance similarity in the second stage in which a low evaluation object region is dealt with. Therefore, the correspondence can be accurately identified.

In the present example embodiment, a configuration is employed in which: in a case where it has been decided to refer to appearance similarity for an object region, the plurality of types of similarity to which predetermined weights have been respectively given are referred to.

Thus, for example, it is possible to determine a predetermined weight in accordance with a characteristic or the like of the moving image F. Therefore, it is possible to identify a correspondence between a high evaluation object region and a tracking target with higher accuracy.

In the present example embodiment, a configuration is employed in which: the evaluation value is calculated based on reliability that the object is included in the object region or on a degree that the object is hidden in the object region.

Thus, it is possible to use an evaluation value in which a degree that an appearance feature of an object can be satisfactorily extracted from an object region is more accurately represented with use of reliability or a degree that the object is hidden.

In the present example embodiment, a configuration is employed in which: for an object region for which a correspondence with the tracking target has not been identified, an object included in that object region is added to management targets as another tracking target in accordance with the evaluation value. For example, an object included in a high evaluation region is added as a new tracking target, and an object included in a low evaluation region is not added.

Thus, it is possible to manage a more appropriate object as a new tracking target, and it is possible to identify a correspondence between the object region and the tracking target with higher accuracy.

In the present example embodiment, a configuration is employed in which: a tracking target for which a correspondence with the object region has not been identified in a plurality of successive frames included in the moving image F is deleted from management targets in accordance with a continuous non-detection period.

Thus, a tracking target which is no longer included in the frame with the passage of time is excluded from a target for which a correspondence is identified. As a result, it is possible to identify a correspondence between the object region and the tracking target with higher accuracy.

### Variation 1

The second example embodiment can be altered so that, in the first correspondence identification process, weights which are respectively given to the plurality of types of similarity (here, appearance similarity and IoU) are varied in accordance with an evaluation value.

In this case, in step S23 of FIG. 4, the decision section 13A decides a weight α and a weight β for a high evaluation object region in accordance with the evaluation value, in addition to deciding, in accordance with the evaluation value, whether the object region is a high evaluation object region or a low evaluation object region. For example, the decision section 13A may increase the weight α as the evaluation value increases (i.e., as the evaluation value approaches 1), and may decrease the weight α as the evaluation value approaches a threshold θhigh. The weight α can be varied continuously or in stages in accordance with the evaluation value. In step S27-4 of the first correspondence identification process, the identification section 14A calculates total similarity with use of the weights α and β which have been decided in step S23.

Thus, for a high evaluation object region for which appearance similarity and positional similarity are referred to, it is possible to change, in accordance with the evaluation value, the degree that appearance similarity is referred to, and thus it is possible to further accurately identify a correspondence with the tracking target.

### Variation 2

In the second example embodiment, it has been described that two stages of processes, i.e., the first correspondence identification process and the second correspondence identification process are included. Note, however, that this configuration can be altered to include a single stage.

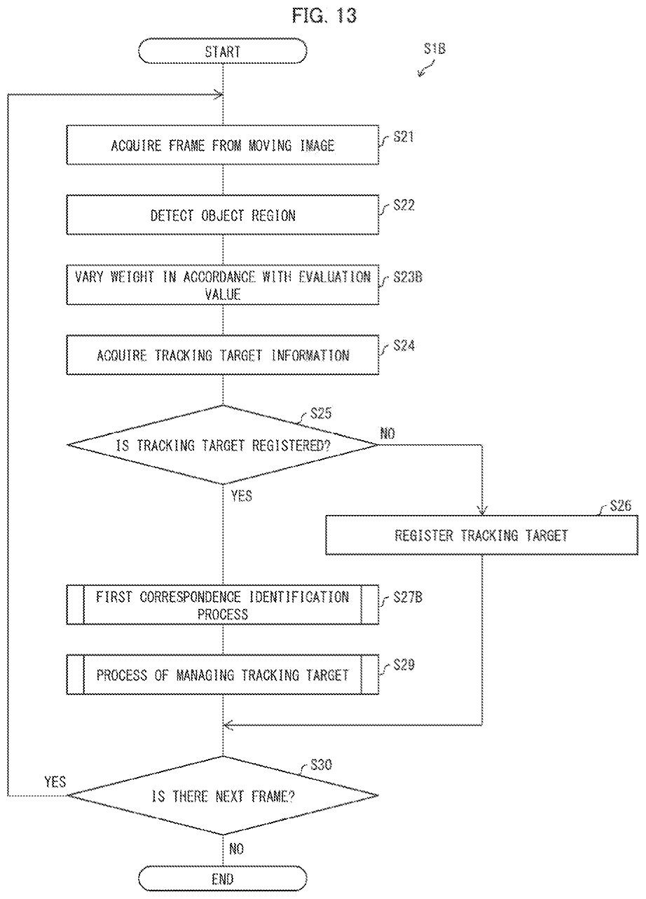

The following description will discuss an object tracking method S1B according to the present variation with reference to FIG. 13. FIG. 13 is a flowchart illustrating a flow of the object tracking method S1B. As illustrated in FIG. 13, the object tracking method S1B includes steps substantially similar to those in the object tracking method S1A but has the following differences. The object tracking method S1B includes steps S23B and S27B instead of steps S23 and S27. Moreover, the object tracking method S1B does not include step S28.

In step S23B, for each of object regions, the decision section 13A varies, in accordance with an evaluation value, weights α and β which are respectively given to a plurality of types of similarity (here, appearance similarity and IoU). Step S23B does not include a process of deciding whether the object region is a high evaluation object region or a low evaluation object region in accordance with the evaluation value, unlike step S23. For example, the decision section 13A may increase the weight α as the evaluation value increases (i.e., as the evaluation value approaches 1), and may decrease the weight α as the evaluation value approaches a lower limit θlow. The weight α can be varied continuously or in stages in accordance with the evaluation value.

In step S27B, the identification section 14A carries out the first correspondence identification process with use of the weights α and β which have been decided in step S23B for each of the object regions. The first correspondence identification process is substantially similar to the flow described above with reference to FIG. 7, but has the following difference. In the present variation, steps S27-1 through S27-4 are carried out for each of object regions included in a target frame, instead of for a high evaluation object region. Thus, a similarity matrix related to each of object regions is generated. Moreover, in step S27-5, a correspondence between each of object regions and a tracking target is identified, instead of a correspondence between a high evaluation object region and a tracking target.

According to the present variation, it is possible to provide a configuration in which a degree that appearance similarity is refer to for an object region for which an evaluation value is relatively low (high) is reduced (increased) by carrying out only a single stage of correspondence identification process. This makes it possible to accurately identify a correspondence between the object region and the tracking target.

### Variation 3

In the second example embodiment, it has been described that two stages of processes, i.e., the first correspondence identification process and the second correspondence identification process are included. Note, however, that this configuration can be altered to include three or more stages.

For example, in the present variation, three stages of processes are carried out, i.e., a first correspondence identification process with respect to a high evaluation object region, a third correspondence identification process with respect to a middle evaluation object region, and a second correspondence identification process with respect to a low evaluation object region are carried out. For the high evaluation object region and the middle evaluation object region, appearance similarity and IoU are referred to. For the low evaluation object region, IoU is referred to without referring to appearance similarity.

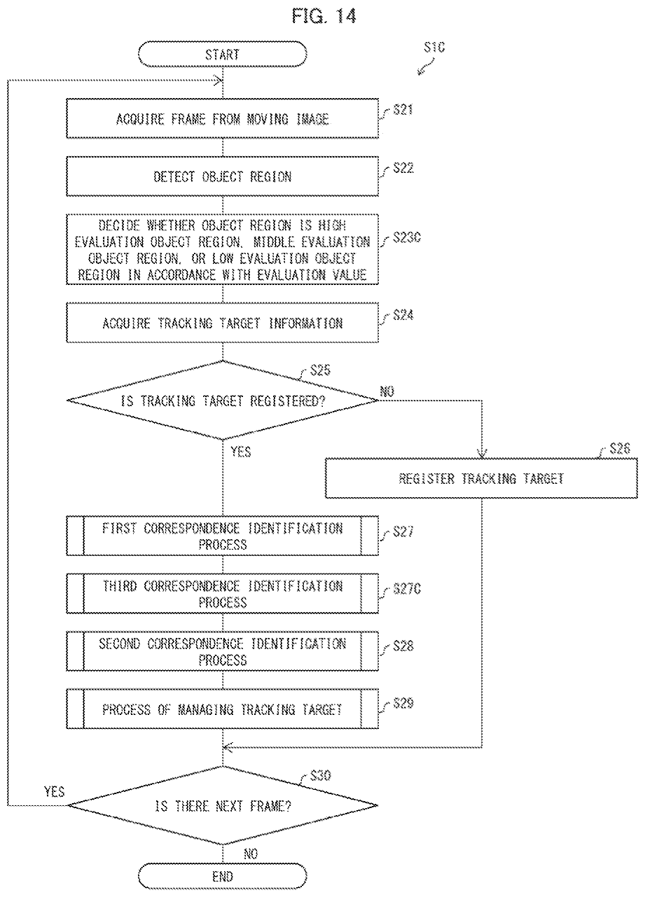

The following description will discuss an object tracking method S1C according to the present variation with reference to FIG. 14. FIG. 14 is a flowchart illustrating a flow of the object tracking method S1C. As illustrated in FIG. 14, the object tracking method S1C includes steps substantially similar to those in the object tracking method S1A, but has the following differences. The object tracking method S1C includes step S23C instead of step S23. The object tracking method S1C further includes step S27C. Step S27C is carried out after step S27 and before step S28.

In step S23C, for each of object regions, the decision section 13A decides whether the object region is regarded as a high evaluation object region, a middle evaluation object region, or a low evaluation object region in accordance with the evaluation value. For example, the decision section 13A may further use a threshold θmid to decide the object region to be a low evaluation object region in a case where the evaluation value is θlow or greater and less than θmid, a middle evaluation object region in a case where the evaluation value is θmid or greater and less than θhigh, and a high evaluation object region in a case where the evaluation value is θhigh or greater and 1 or less.

In step S27C, the identification section 14A carries out the third correspondence identification process for a tracking target for which a correspondence has not been identified in the first correspondence identification process. Details of the third correspondence identification process are similarly described by replacing the high evaluation object region with the middle evaluation object region in the above description of the first correspondence identification process. The weights α and β which are used in step S27-4 of the third correspondence identification process may be identical with or different from the weights α and β which are used in step S27-4 of the first correspondence identification process. In the case of being different, the weight α used in step S27-4 of the third correspondence identification process may be smaller than the weight α used in step S27-4 of the first correspondence identification process.

In step S28, the identification section 14A carries out the second correspondence identification process for a tracking target for which a correspondence has not been identified in the third correspondence identification process. Details of the second correspondence identification process are as described above.

As described above, in the present variation, by carrying out the process of identifying a correspondence with a tracking target in three or more stages, the correspondence with the tracking target can be accurately identified in consideration of an object region having a moderate evaluation value.

### Variation 4

In the second example embodiment, in order to calculate appearance similarity, an appearance feature that has been most recently extracted for a tracking target is referred to. Here, the appearance feature of the tracking target which is referred to for referring to appearance similarity can be altered as follows.

In the present variation, as an appearance feature of a tracking target which is referred to for calculating appearance similarity, the identification section 14A refers to an appearance feature that is predicted for the tracking target in a target frame.

For example, the following description will discuss a case where the tracking target is a person. The appearance feature includes a posture of the person. In this case, the identification section 14A may predict a posture of the tracking target in the target frame based on the posture of the tracking target which has been extracted from a plurality of frames before the target frame. The posture of the tracking target is represented by, for example, an arrangement of a plurality of feature points which are extracted from the tracking target region. The identification section 14A calculates, as appearance similarity, similarity between a posture of an object extracted from an object region in the target frame and the posture predicted for the tracking target.

Note that the identification section 14A can predict, with use of a prediction model, an appearance feature that is predicted for the tracking target. For example, the prediction model can be a model into which images of a tracking target region in a plurality of frames before the target frame are input, and which outputs a prediction image of the tracking target region. In this case, the identification section 14A extracts an appearance feature from the prediction image output from the prediction model to calculate an appearance feature that is predicted for the tracking target. For example, the prediction model can be a model into which appearance features of a tracking target extracted from a plurality of frames before the target frame are input, and which outputs an appearance feature that is predicted for the tracking target. The prediction model can be constructed by machine learning.

### Variation 5

Moreover, the appearance feature of the tracking target which is referred to for calculating the appearance similarity in the second example embodiment can be altered as follows.

In the present variation, the management section 15A registers a new appearance feature in addition to a previous appearance feature, instead of updating, in step S29-8, an appearance feature for a tracking target for which a correspondence with a high evaluation object region has been identified. Thus, the tracking target information 21 includes a history of appearance features for the tracking target in addition to the information illustrated in FIG. 6. The history of appearance features is a sequence of appearance features extracted from respective frames before the target frame. Hereinafter, each of the appearance features included in the history of appearance features is also referred to as a past appearance feature.

Moreover, the identification section 14A refers to the history of appearance features stored in the tracking target information 21, and thus refers to one or more past appearance features of the tracking target to calculate appearance similarity. For example, it is possible that the identification section 14A refers to, for a tracking target, a past appearance feature for which similarity with an appearance feature of the object is highest among the past appearance features, and sets the highest similarity to be the appearance similarity. Alternatively, for example, the identification section 14A can calculate appearance similarity with reference to, among the past appearance features, a past appearance feature for which an evaluation value of a tracking target region, from which that appearance feature has been extracted, is similar to an evaluation value of the object region. Alternatively, for example, the identification section 14A can calculate appearance similarity with reference to values (e.g., an average value, a weighted average value, a maximum value, a minimum value, and the like) which have been calculated from some of or all of the past appearance features. In a case where a weighted average value is used, for example, a higher weight may be given to a past appearance feature which has been extracted from a frame that is closer to the target frame. The some of or all of the past appearance features may be past appearance features during a predetermined period of time until immediately before the target frame. Alternatively, the some of or all of the past appearance features may be past appearance features for which similarity with an appearance feature of the object is not less than a threshold or is up to a predetermined level.

### Variation 6

In the second example embodiment, in order to calculate IoU, a tracking target region in a detection frame in which a tracking target has been most recently detected is referred to. Here, the tracking target region which is referred to for referring to the IoU can be altered as follows.

In the present variation, the identification section 14A refers to, as a tracking target region which is referred to for calculating the IoU, a region that is predicted to include a tracking target in a target frame. For example, the region including the tracking target in the target frame can be predicted based on tracking target regions which have been detected in a plurality of frames before the target frame. Such a technique for predicting a position of a tracking target region can be a known technique such as a Kalman filter.

### Variation 7

The second example embodiment can also be altered to include other types of similarity in addition to appearance similarity and IoU as the plurality of types of similarity. For example, specific examples of such other types of similarity include similarity that is based on a moving speed, a feature point, a size, or a position in a three-dimensional space of each of an object region and a tracking target region, and the like.

In the present variation, in the first correspondence identification process, the identification section 14A calculates total similarity while giving weights of α, β, γ, and so forth to respective three or more types of similarity including appearance similarity and IoU. In the second correspondence identification process, the identification section 14A calculates total similarity while giving weights of β, γ, and so forth to respective two or more types of similarity which includes IoU and does not include appearance similarity.

For example, similarity based on a moving speed is similarity between a moving speed of an object region and a moving speed of a tracking target region. The moving speed of the object region can be calculated from the object region in the target frame and tracking target regions respectively in a plurality of past frames, where it is assumed that the object region corresponds to the tracking target. The moving speed of the tracking target can be calculated from tracking target regions respectively in the plurality of past frames. For example, there are cases where appearance similarity is high but moving speeds are greatly different (e.g., a case where two objects which have similar appearance features but are different from each other move in the opposite directions and pass each other). By using the similarity based on the moving speed, it is possible to further accurately calculate the total similarity.

For example, the similarity based on a feature point is calculated as similarity between a feature point extracted from the object region and a feature point extracted from the tracking target region. For example, in a case where the tracking target is a person, an arrangement of such feature points represents a posture or a feature of a face. By using the similarity based on the feature point, it is possible to further accurately calculate the total similarity.

For example, the similarity based on a size is similarity based on a size of the object region and on a size of the tracking target region. For example, there are cases where the IoU is high but the sizes are greatly different (e.g., a case where one of these regions encompasses the most part of the other). By using the similarity based on the size, it is possible to further accurately calculate the total similarity.

For example, the similarity based on a position in a three-dimensional space is calculated as similarity between a position of the object region and a position of the tracking target region in the three-dimensional space. For example, the positions of the respective regions in the three-dimensional space can be inferred based on frames included in the moving image F. For example, even in a case where positions of two object regions are close to each other in a two-dimensional frame, the two object regions may be far apart from each other in a three-dimensional space. By using the similarity based on the position in the three-dimensional space, it is possible to further accurately calculate the total similarity.

### Variation 8

In the second example embodiment, the management process in step S28-8 can be altered as follows.

In the present variation, the management section 15A compares, for a tracking target for which a correspondence with a high evaluation object region has been identified, an appearance feature stored in the tracking target information 21 with an appearance feature of that tracking target extracted from the high evaluation object region, and determines whether or not a difference between these appearance features is large. In a case where it has been determined that the difference is large, the management section 15A updates, in the tracking target information 21, the appearance feature of the tracking target with the appearance feature extracted from the high evaluation object region. In a case where it has been determined that the difference is small, the management section 15A does not update the appearance feature of the tracking target.

According to the present variation, it is possible to reduce a storage area for storing an appearance feature in the storage section 120.

### Variation 9

The second example embodiment can be altered to account for a plurality of classifications related to tracking targets. Examples of the plurality of classifications include, but not limited to, a person, a vehicle, an animal, and the like. In the present variation, the detection section 12A calculates, for each of object regions, an evaluation value for each classification. The management section 15A stores a tracking target in the tracking target information 21 in association with a classification having a highest degree of likelihood. The decision section 13A decides, for each of object regions, a degree that appearance similarity is referred to for each classification. In the first correspondence identification process, the identification section 14A identifies a correspondence between a tracking target and a high evaluation object region that corresponds to an evaluation value corresponding to a classification of that tracking target. In the second correspondence identification process, the identification section 14A identifies a correspondence between a tracking target and a low evaluation object region that corresponds to an evaluation value corresponding to a classification of that tracking target.

According to the present variation, it is possible to improve tracking accuracy even in a case where there can be two or more categories of tracking targets.

### Software Implementation Example

The functions of part of or all of the object tracking apparatuses 1 and 1A can be realized by hardware such as an integrated circuit (IC chip) or can be alternatively realized by software.

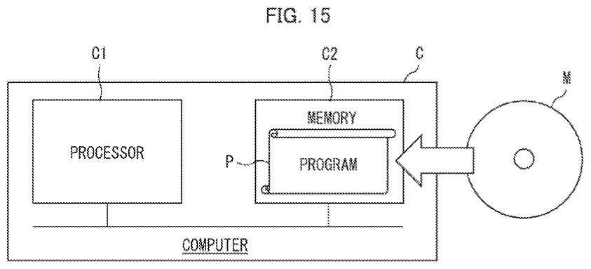

In the latter case, each of the object tracking apparatuses 1 and 1A is realized by, for example, a computer that executes instructions of a program that is software realizing the foregoing functions. FIG. 15 illustrates an example of such a computer (hereinafter, referred to as “computer C”). The computer C includes at least one processor C1 and at least one memory C2. The memory C2 stores a program P for causing the computer C to function as the object tracking apparatuses 1 and 1A. In the computer C, the processor C1 reads the program P from the memory C2 and executes the program P, so that the functions of the object tracking apparatuses 1 and 1A are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### Supplementary Note 1

An object tracking apparatus including: an image acquisition means of acquiring an image from an image sequence; a detection means of detecting an object region including an object from the image, and calculating an evaluation value related to the object region; a decision means of deciding, in accordance with the evaluation value, to what degree appearance similarity is referred to among a plurality of types of similarity which are used to associate the object region with a tracking target in the image sequence, the appearance similarity being based on appearance features of the object and the tracking target;

and an identification means of referring to at least any of the plurality of types of similarity based on a decision result by the decision means to identify a correspondence between the object region and the tracking target.

### Supplementary Note 2

The object tracking apparatus according to supplementary note 1, wherein: the plurality of types of similarity further include positional similarity which is based on a position of the object region in the image and on a position of a tracking target region that is associated with the tracking target.

### Supplementary Note 3

The object tracking apparatus according to supplementary note 1 or 2, in which: in a case where there are two or more object regions and two or more tracking targets, the decision means decides whether each of the two or more object regions is regarded as a first object region or a second object region in accordance with the evaluation value related to that object region, the first object region being an object region for which the appearance similarity is referred to, and the second object region being an object region for which the appearance similarity is not referred to; and the identification means carries out a first correspondence identification process and a second correspondence identification process, the first correspondence identification process being a process of identifying a correspondence between the first object region and each of the two or more tracking targets, and the second correspondence identification process being a process of identifying a correspondence between the second object region and each tracking target for which a correspondence is not identified in the first correspondence identification process.

### Supplementary Note 4

The object tracking apparatus according to any one of supplementary notes 1 through 3, in which: in a case where the decision means has decided to refer to the appearance similarity, the identification means refers to the plurality of types of similarity to which predetermined weights have been respectively given.

### Supplementary Note 5

The object tracking apparatus according to any one of supplementary notes 1 through 3, in which: the decision means varies, in accordance with the evaluation value, weights which are respectively given to the plurality of types of similarity.

### Supplementary Note 6

The object tracking apparatus according to supplementary note 2, in which: in a case where the decision means has decided not to refer to the appearance similarity, the identification means refers to at least the positional similarity.

### Supplementary Note 7

The object tracking apparatus according to any one of supplementary notes 1 through 6, in which: the detection means calculates the evaluation value based on reliability that the object is included in the object region or on a degree that the object is hidden in the object region.

### Supplementary Note 8

The object tracking apparatus according to any one of supplementary notes 1 through 7, in which: as the appearance feature of the tracking target which is referred to for calculating the appearance similarity, the identification means refers to an appearance feature that is predicted for the tracking target in the image.

### Supplementary Note 9

The object tracking apparatus according to any one of supplementary notes 1 through 8, in which: the plurality of types of similarity further include similarity that is based on a moving speed, a feature point, a size, or a position in a three-dimensional space of the object region and the tracking target region which is associated with the tracking target.

### Supplementary Note 10

The object tracking apparatus according to any one of supplementary notes 1 through 9, further including: a management means of managing the tracking target, the management means adding, for an object region for which a correspondence with the tracking target has not been identified, an object included in that object region to management targets as another tracking target in accordance with the evaluation value.

### Supplementary Note 11

The object tracking apparatus according to any one of supplementary notes 1 through 9, further including: a management means of managing the tracking target, the management means deleting, from management targets in accordance with a continuous period, a tracking target for which a correspondence with the object region has not been identified in a plurality of successive images included in the image sequence.

### Supplementary Note 12

An object tracking method including: acquiring an image from an image sequence; detecting an object region including an object from the image, and calculating an evaluation value related to the object region; deciding, in accordance with the evaluation value, to what degree appearance similarity is referred to among a plurality of types of similarity which are used to associate the object region with a tracking target in the image sequence, the appearance similarity being based on appearance features of the object and the tracking target; and referring to at least any of the plurality of types of similarity based on a decision result to identify a correspondence between the object region and the tracking target.

### Supplementary Note 13

A program for causing a computer to function as an object tracking apparatus, the program causing the computer to function as: an image acquisition means of acquiring an image from an image sequence; a detection means of detecting an object region including an object from the image, and calculating an evaluation value related to the object region; a decision means of deciding, in accordance with the evaluation value, to what degree appearance similarity is referred to among a plurality of types of similarity which are used to associate the object region with a tracking target in the image sequence, the appearance similarity being based on appearance features of the object and the tracking target; and an identification means of referring to at least any of the plurality of types of similarity based on a decision result by the decision means to identify a correspondence between the object region and the tracking target.

### Supplementary Note 14

An object tracking apparatus comprising at least one processor, the at least one processor carrying out: an image acquisition process of acquiring an image from an image sequence; a detection process of detecting an object region including an object from the image, and calculating an evaluation value related to the object region; a decision process of deciding, in accordance with the evaluation value, to what degree appearance similarity is referred to among a plurality of types of similarity which are used to associate the object region with a tracking target in the image sequence, the appearance similarity being based on appearance features of the object and the tracking target; and an identification process of referring to at least any of the plurality of types of similarity based on a decision result in the decision process to identify a correspondence between the object region and the tracking target.

Note that the object tracking apparatus can further include a memory. The memory can store a program for causing the processor to carry out the image acquisition process, the detection process, the decision process, and the identification process. The program can be stored in a computer-readable non-transitory tangible storage medium.

### REFERENCE SIGNS LIST

1, 1A: Object tracking apparatus
11, 11A: Image acquisition section
12, 12A: Detection section
13, 13A: Decision section
14, 14A: Identification section
15A: Management section
21: Tracking target information
110: Control section
120: Storage section
C1: Processor
C2: Memory

1. An object tracking apparatus comprising at least one processor, the at least one processor carrying out:
an image acquisition process of acquiring an image from an image sequence;
a detection process of detecting an object region including an object from the image, and calculating an evaluation value related to the object region;
a decision process of deciding, in accordance with the evaluation value, to what degree appearance similarity is referred to among a plurality of types of similarity which are used to associate the object region with a tracking target in the image sequence, the appearance similarity being based on appearance features of the object and the tracking target; and
an identification process of referring to at least any of the plurality of types of similarity based on a decision result in the decision process to identify a correspondence between the object region and the tracking target.

2. The object tracking apparatus according to claim 1, wherein:
the plurality of types of similarity further include positional similarity which is based on a position of the object region in the image and on a position of a tracking target region that is associated with the tracking target.

3. The object tracking apparatus according to claim 1, wherein:
in a case where there are two or more object regions and two or more tracking targets, whether each of the two or more object regions is regarded as a first object region or a second object region is decided in the decision process in accordance with the evaluation value related to that object region, the first object region being an object region for which the appearance similarity is referred to, and the second object region being an object region for which the appearance similarity is not referred to; and
the identification process includes a first correspondence identification process and a second correspondence identification process, the first correspondence identification process being a process of identifying a correspondence between the first object region and each of the two or more tracking targets, and the second correspondence identification process being a process of identifying a correspondence between the second object region and each tracking target for which a correspondence is not identified in the first correspondence identification process.

4. The object tracking apparatus according to claim 1, wherein:
in a case where it has been decided to refer to the appearance similarity in the decision process, the plurality of types of similarity to which predetermined weights have been respectively given are referred to in the identification process.

5. The object tracking apparatus according to claim 1, wherein:
in the decision process, weights which are respectively given to the plurality of types of similarity are varied in accordance with the evaluation value.

6. The object tracking apparatus according to claim 2, wherein:
in a case where it has been decided not to refer to the appearance similarity in the decision process, at least the positional similarity is referred to in the identification process.

7. The object tracking apparatus according to claim 1, wherein:
in the detection process, the evaluation value is calculated based on reliability that the object is included in the object region or on a degree that the object is hidden in the object region.

8. The object tracking apparatus according to claim 1, wherein:
in the identification process, an appearance feature that is predicted for the tracking target in the image is referred to as the appearance feature of the tracking target which is referred to for calculating the appearance similarity.

9. The object tracking apparatus according to claim 1, wherein:
the plurality of types of similarity further include similarity that is based on a moving speed, a feature point, a size, or a position in a three-dimensional space of the object region and a tracking target region which is associated with the tracking target.

10. The object tracking apparatus according to claim 1, wherein:
the at least one processor further carries out a management process of managing the tracking target; and
in the management process, for an object region for which a correspondence with the tracking target has not been identified, an object included in that object region is added to management targets as another tracking target in accordance with the evaluation value.

11. The object tracking apparatus according to claim 1, wherein:
the at least one processor further carries out a management process of managing the tracking target; and
in the management process, a tracking target for which a correspondence with the object region has not been identified in a plurality of successive images included in the image sequence is deleted from management targets in accordance with a continuous period.

12. An object tracking method, comprising:
acquiring an image from an image sequence;
detecting an object region including an object from the image, and calculating an evaluation value related to the object region;
deciding, in accordance with the evaluation value, to what degree appearance similarity is referred to among a plurality of types of similarity which are used to associate the object region with a tracking target in the image sequence, the appearance similarity being based on appearance features of the object and the tracking target; and
referring to at least any of the plurality of types of similarity based on a decision result to identify a correspondence between the object region and the tracking target.

13. A non-transitory storage medium storing a program for causing a computer to function as an object tracking apparatus, the program causing the computer to carry out:
an image acquisition process of acquiring an image from an image sequence;
a detection process of detecting an object region including an object from the image, and calculating an evaluation value related to the object region;
a decision process of deciding, in accordance with the evaluation value, to what degree appearance similarity is referred to among a plurality of types of similarity which are used to associate the object region with a tracking target in the image sequence, the appearance similarity being based on appearance features of the object and the tracking target; and
an identification process of referring to at least any of the plurality of types of similarity based on a decision result in the decision process to identify a correspondence between the object region and the tracking target.
